(19) United States
(12) Patent Application Publication
(10) Pub. No.: US 2023/0094460 A1
(43) Pub. Date: Mar. 30, 2023

(54) COMPOSITE REBAR WITH POST-GRINDING SURFACE TREATMENT

(71) Applicant: Owens Corning Intellectual Capital, LLC, Toledo, OH (US)

(72) Inventors: James Priest, Frazeysburg, OH (US); David Hartman, Granville, OH (US); Kevin Spoo, Utica, OH (US); David Molnar, Newark, OH (US)

(21) Appl. No.: 17/801,280

(22) PCT Filed: Feb. 23, 2021
(86) PCT No.: PCT/US21/19150

§ 371 Date: Aug. 22, 2022

Related U.S. Application Data
(60) Provisional application No. 62/990,465, filed on Mar. 17, 2020.

(51) Int. Cl. E04C 5/07; B29C 70/20; B29C 70/00

(52) U.S. Cl. CPC E04C 5/07; B29C 70/205; B29C 70/003; B29L 2031/06

(57) ABSTRACT

A composite rebar having ridges formed therein by grinding is buffed and/or coated to reduce the surface roughness caused by fibers extending from the rebar.

### CROSS-REFERENCE TO RELATED APPLICATIONS

This application claims priority to and all benefit of U.S. Provisional Patent Application No. 62/990,465, filed on Mar. 17, 2020, the entire disclosure of which is fully incorporated herein by reference.

### FIELD

The invention generally relates to reinforcement materials and, more particularly, to composite rebar with a post-grinding surface treatment.

### BACKGROUND

Composite rebar is a known substitute for steel rebar. Rebar, short for reinforcing bar, is used as a tension device in reinforced concrete to strengthen and hold the concrete in compression. Composite rebar is formed from fibers (e.g., glass, carbon) held together by a resin matrix (i.e., binder). The binder could be a thermoset or thermoplastic resin. Given that rebar typically has a constant cross-section, pultrusion is a process well suited for forming the fiber-reinforced plastic/polymer (FRP) rebar. As with steel rebar, it is known to introduce surface features in the composite rebar to provide anchor points between the composite rebar and the concrete. These anchor points ensure strong mechanical interlock between the composite rebar and the concrete.

Conventionally, these anchor points were formed on the composite rebar by wrapping additional material (e.g., a fiber strand) around an outer surface of the fibrous rod, such as shown in U.S. Pat. No. 4,620,401 (the entire disclosure of which is incorporated herein by reference). As shown in FIG. 1, such a process 100 involves forming the composite rod (step 102) and then applying the wrapping to the rod to create the raised ribs (step 104). Any pre-forming processing is denoted by “A” in FIG. 1, while any post-wrapping processing is denoted by “B” in FIG. 1. The resulting composite rebar 200 is shown in FIG. 2. The composite rebar 200 includes a composite body 202 having a relatively uniform thickness T. As the composite body 202 is a generally cylindrical member, the thickness T of the composite body 202 is defined by a diameter of the cylindrical member. A helical wrapping 204 is formed or otherwise disposed on an outer surface of the composite body 202. The helical wrapping 204 forms a plurality of raised ribs 206 that are spaced apart from one another and extend beyond the thickness T of the composite body 202.

In view of the above, an unmet need remains for a process of forming anchor points on composite rebar, which does not require interfacing additional material with a pultruded rod.

### SUMMARY

In view of the above, the general inventive concepts contemplate and encompass a composite rebar having a plurality of anchor points formed therein by removing material from the composite rebar. More specifically, a grinding operation is used to remove portions of the composite rebar to create raised portions separated by the removed portions. To account for any fibers exposed during the grinding operation, the composite rebar is subsequently buffed and/or coated.

In one exemplary embodiment, a method of forming a composite rebar is disclosed. The method comprises forming a rod by combining a plurality of relatively parallel fibers with a resin, said resin being cured to solidify the rod; and grinding the rod to remove a portion of the fibers and the resin.

In some exemplary embodiments, the fibers are glass fibers.

In some exemplary embodiments, the resin is a vinyl ester resin. In some exemplary embodiments, the resin is an epoxy resin. In some exemplary embodiments, the resin is a resin that comports with ASTM D7957. In some exemplary embodiments, the resin is a resin that comports with Canadian Standard 5807.

In some exemplary embodiments, the grinding forms a continuous helical groove in the rod. In some exemplary embodiments, the helical groove has a width in the range of 0.200 inches to 0.260 inches. In some exemplary embodiments, the helical groove has a width in the range of 0.240 inches to 0.260 inches. In some exemplary embodiments, the helical groove has a depth in the range of 0.007 inches to 0.020 inches. In some exemplary embodiments, the helical groove has a depth in the range of 0.008 inches to 0.016 inches. In some exemplary embodiments, the helical groove has a pitch (i.e., the distance along the lengthwise axis of the rod covered by one full (360°) rotation of the groove) in the range of 0.380 inches to 0.420 inches.

In some exemplary embodiments, the method further comprises buffing at least one surface of the helical groove.

In some exemplary embodiments, the method further comprises coating at least one surface of the helical groove.

In some exemplary embodiments, the method further comprises buffing at least one surface of the helical groove and then coating the at least one surface of the helical groove after said buffing.

In one exemplary embodiment, a composite rebar is disclosed. The composite rebar comprises a rod comprising a plurality of relatively parallel fibers joined by a cured resin, wherein a continuous helical groove is formed along a length of the rod.

In some exemplary embodiments, the fibers are glass fibers.

In some exemplary embodiments, the resin is a vinyl ester resin. In some exemplary embodiments, the resin is an epoxy resin. In some exemplary embodiments, the resin is a resin that comports with ASTM D7957. In some exemplary embodiments, the resin is a resin that comports with Canadian Standard 5807.

In some exemplary embodiments, the helical groove has a width in the range of 0.200 inches to 0.260 inches. In some exemplary embodiments, the helical groove has a width in the range of 0.240 inches to 0.260 inches. In some exemplary embodiments, the helical groove has a depth in the range of 0.007 inches to 0.020 inches. In some exemplary embodiments, the helical groove has a depth in the range of 0.008 inches to 0.016 inches. In some exemplary embodiments, the helical groove has a pitch (i.e., the distance along the lengthwise axis of the rod covered by one full (360°) rotation of the groove) in the range of 0.380 inches to 0.420 inches.

In some exemplary embodiments, the helical groove has a buffed surface.

In some exemplary embodiments, the helical groove has a coated surface.

In some exemplary embodiments, the helical groove has a buffed and coated surface.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

FIG. 1 is a diagram of a conventional method of forming anchor points on an external surface of a composite rebar.

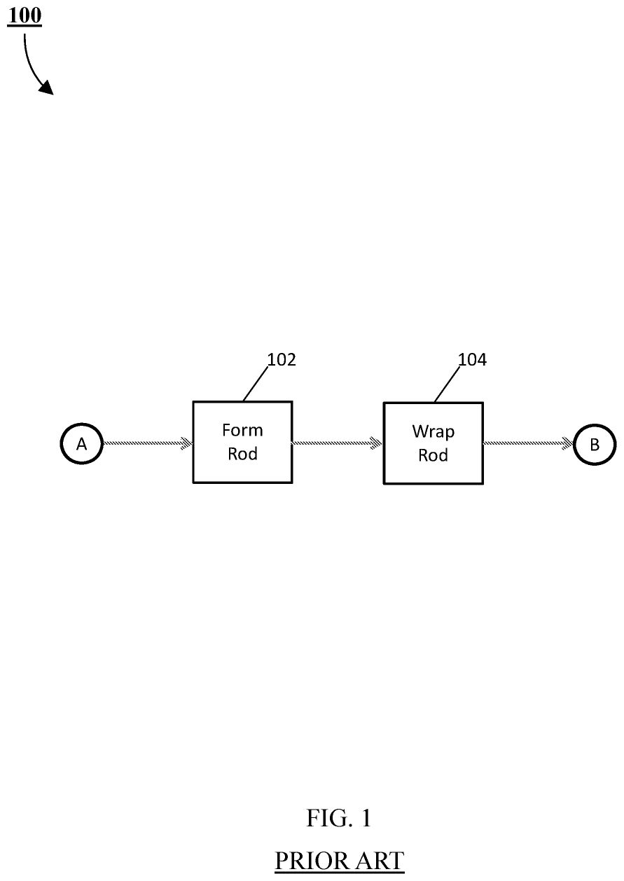

FIG. 2 is a side view of a portion of a conventional composite rebar produced by the method of FIG. 1.

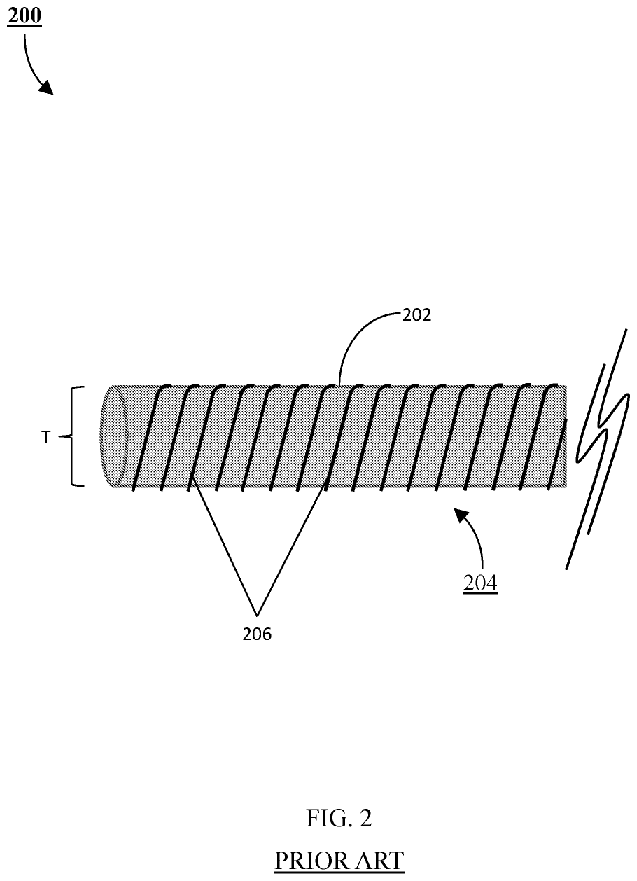

FIG. 3 is a diagram of a method of forming anchor points in a composite rebar by removing material therefrom, according to an exemplary embodiment.

FIG. 4 is a side view of a portion of a composite rebar produced by the method of FIG. 3.

FIG. 5 is a detailed view of a portion of the composite rebar of FIG. 4.

FIG. 6 is a diagram of a method of forming anchor points in a composite rebar by removing material therefrom, according to an exemplary embodiment.

FIG. 7 is a modified version of the detailed view of FIG. 5 showing a portion of a composite rebar produced by the method of FIG. 6.

FIG. 8 is a diagram of a method of forming anchor points in a composite rebar by removing material therefrom, according to an exemplary embodiment.

FIG. 9 is a modified version of the detailed view of FIG. 5 showing a portion of a composite rebar produced by the method of FIG. 8.

FIG. 10 is a diagram of a method of forming anchor points in a composite rebar by removing material therefrom, according to an exemplary embodiment.

FIG. 11 is a modified version of the detailed view of FIG. 5 showing a portion of a composite rebar produced by the method of FIG. 10.

### DETAILED DESCRIPTION

While the general inventive concepts are susceptible of embodiment in many different forms, there are shown in the drawings and will be described in detail herein specific embodiments thereof with the understanding that the present disclosure is to be considered merely as an exemplification of the general inventive concepts. Accordingly, the general inventive concepts are not intended to be limited to the specific embodiments illustrated herein.

As noted above, the general inventive concepts contemplate and encompass a composite rebar having a plurality of anchor points formed therein by removing material from the composite rebar. For example, raised portions (i.e., ribs) are formed in a pultruded composite rod by grinding, thereby forming anchor points in the rod. To account for any fibers exposed during the grinding operation, the rod is subsequently buffed and/or coated.

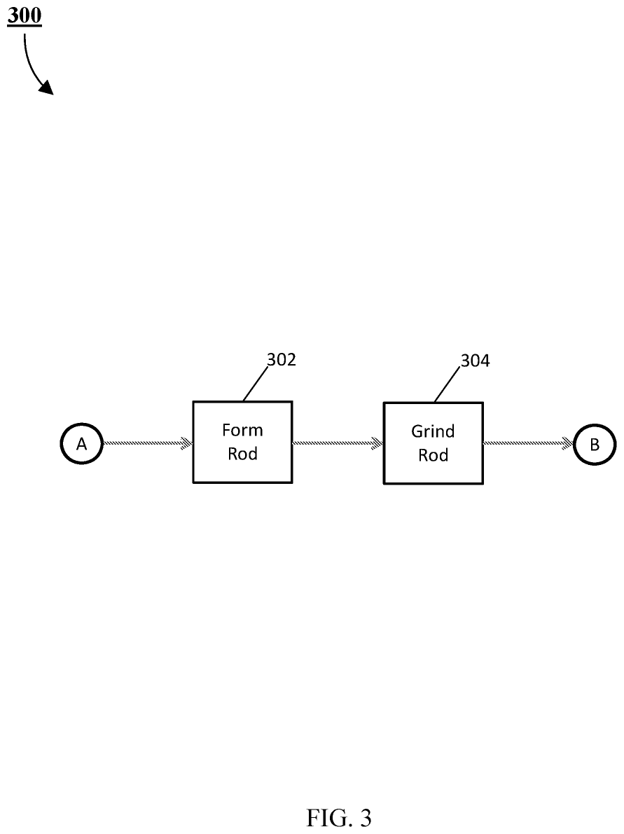

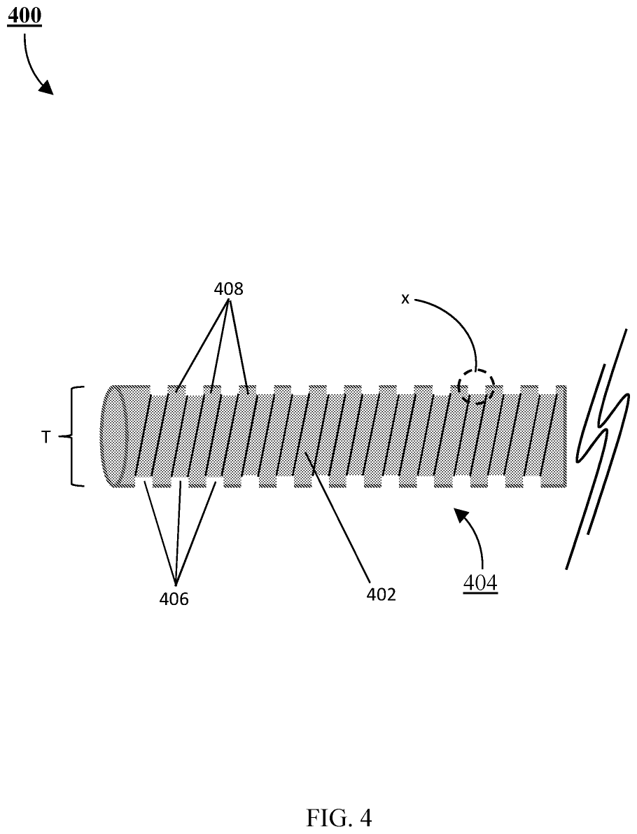

An improved composite rebar 400, as shown in FIG. 4, is proposed. An exemplary method 300 of forming the composite rebar 400 will be described with reference to FIG. 3. The method 300 involves forming the composite rod (step 302) and then grinding the rod to remove material therefrom to create the ribs (step 304). Any pre-forming processing is denoted by “A” in FIG. 3, while any post-grinding processing is denoted by “B” in FIG. 3.

In step 302, the composite rod can be formed in any suitable manner, such as by pultrusion. In some exemplary embodiments, step 302 is the same as step 102. In some exemplary embodiments, the composite rod is formed from glass fibers held together by a binder. Any suitable binder may be used. In some exemplary embodiments, the binder is a vinyl ester resin. In some exemplary embodiments, the binder is an epoxy resin. In some exemplary embodiments, the binder is a resin that comports with ASTM D7957. In some exemplary embodiments, the binder is a resin that comports with Canadian Standard 5807.

In step 304, the composite rod is subject to an operation, such as mechanical grinding, that removes a portion of the composite material from the rod. In the case of mechanical grinding, a continuous (angled) channel is formed in the composite rod. In some exemplary embodiments, the grinding apparatus is fixed, while the composite rod moves relative thereto. In some exemplary embodiments, the composite rod is fixed, while the grinding apparatus moves relative thereto.

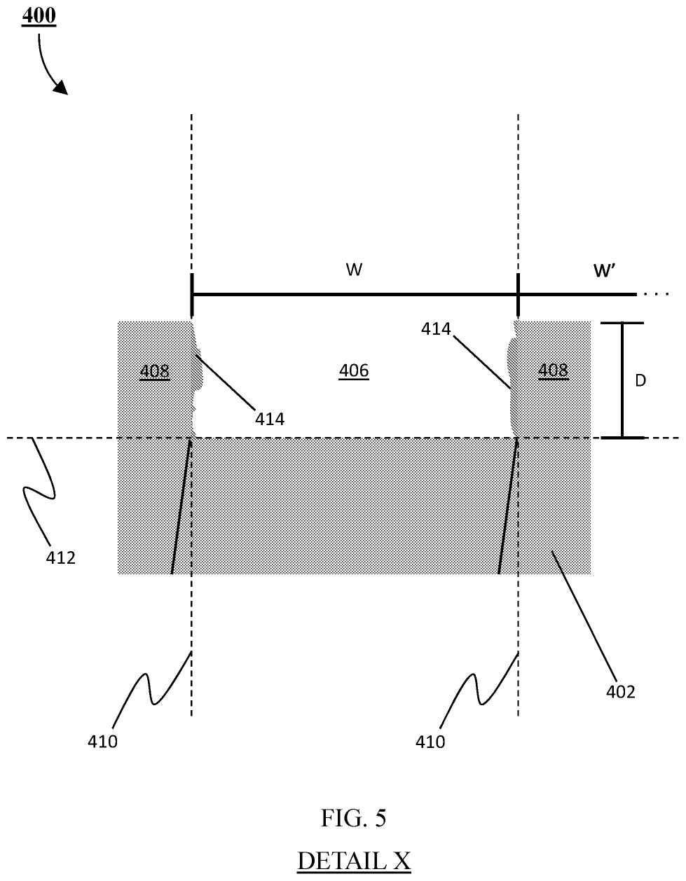

The resulting composite rebar 400 includes a composite body 402 having a relatively uniform thickness T. As the composite body 402 is a generally cylindrical member, the thickness T of the composite body 402 is defined by a diameter of the cylindrical member. As the composite body 402 is ground to remove material therefrom, a helical channel 404 is formed therein. Consequently, the thickness T is no longer uniform along a length of the composite body 402. The helical channel 404 creates spaced apart removed portions 406 and remaining portions 408 that together form a plurality of anchor points in the composite rebar 400. The removed portions 406 are formed to a width W and a depth D, as shown in FIG. 5. The remaining portions 408 do not extend beyond the original (i.e., pre-grinding) thickness T of the composite body 402.

In some exemplary embodiments, the width W is greater than the depth D. In some exemplary embodiments, the width W is less than the depth D. In some exemplary embodiments, the width W is equal to the depth D. In some exemplary embodiments, the width W is greater than a width W′ of the remaining portions 408. In some exemplary embodiments, the width W is less than the width W′. In some exemplary embodiments, the width W is equal to the width W′.

The removed portions 406 are formed by grinding the composite body 402 to the desired width W, which is also shown by the dashed lines 410, and the desired depth D, which is also shown by the dashed line 412. A consequence of the grinding process (step 304) is that some of the fibers making up the composite body 402 break and/or protrude out, which is represented graphically in FIG. 5 as the protruding portions 414 extending beyond the lines 410 and into the cavity formed by the removed portion 406. It was discovered that these protruding fibers make safe/comfortable handling of the composite rebar 400 product difficult.

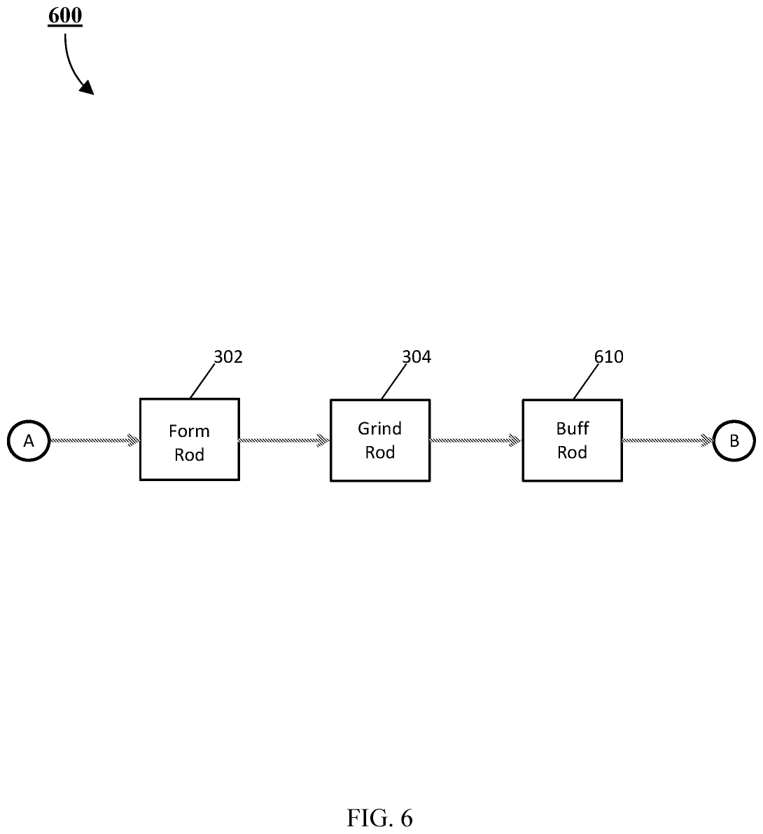

Accordingly, in one exemplary embodiment, a method 600 of forming an improved composite rebar 700 is shown in FIG. 6. The method 600 involves forming the composite rod (step 302), grinding the rod to remove material therefrom to create the ribs (step 304), and thereafter buffing those portions of the rod where material was removed (step 610). Any pre-forming processing is denoted by “A” in FIG. 6, while any post-buffing processing is denoted by “B” in FIG. 6.

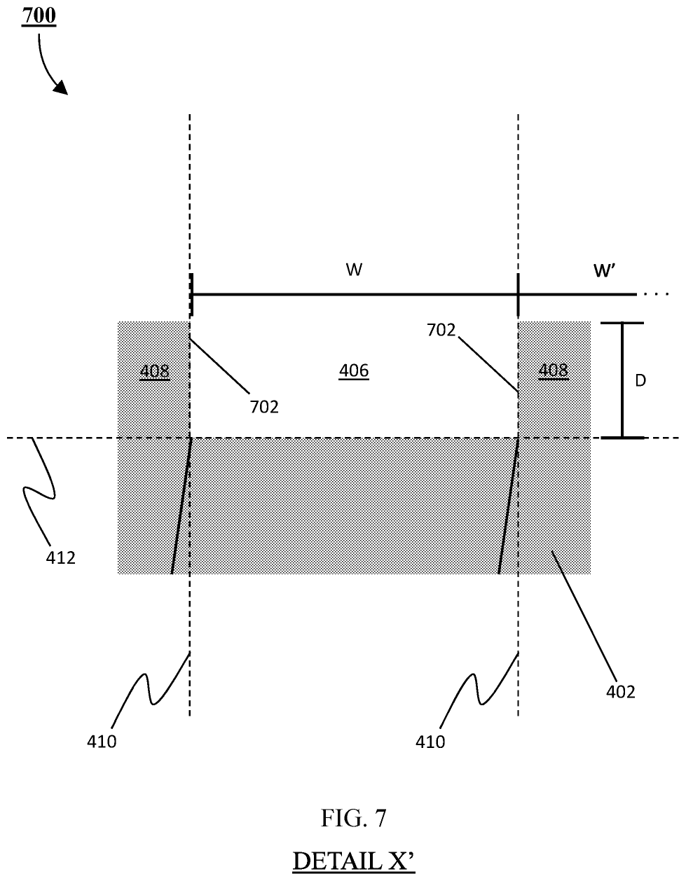

In step 610, the buffing can be performed in any suitable manner. In some exemplary embodiments, a finely abrasive material is used to polish the protruding portions 414 extending beyond the lines 410 to entirely, or otherwise significantly, remove the protruding portions 414 and form buffed surfaces 702, as shown in FIG. 7. Examples of buffing techniques include, but are not limited to, use of an abrasive wheel, a scouring pad, a sanding device, a fibrous brush, or deburring chips.

A measure of the surface roughness of the removed portions 406 (or any relevant portions thereof) after buffing is greatly reduced when compared to the surface roughness of the removed portions 406 prior to buffing.

In step 610, the composite rod is subject to an operation, such as mechanical buffing, that smooths a portion of the rod having fibers protruding therefrom. In the case of mechanical buffing, the buffing apparatus will typically follow the continuous (angled) channel formed by the grinding of the composite rod. In some exemplary embodiments, the buffing apparatus is fixed, while the composite rod moves relative thereto. In some exemplary embodiments, the composite rod is fixed, while the buffing apparatus moves relative thereto.

A portion of the resulting composite rebar 700 having the buffed surface 702 is shown in FIG. 7, which is a modified version of the detailed view of FIG. 5. Because of the buffing operation, the protruding portions 414 (created by the grinding operation) have been removed or otherwise reduced. In other words, a surface smoothness of the helical channel 404 is increased by virtue of the buffing operation (i.e., the buffed surface 702), which renders the composite rebar 700 more safe/comfortable to handle.

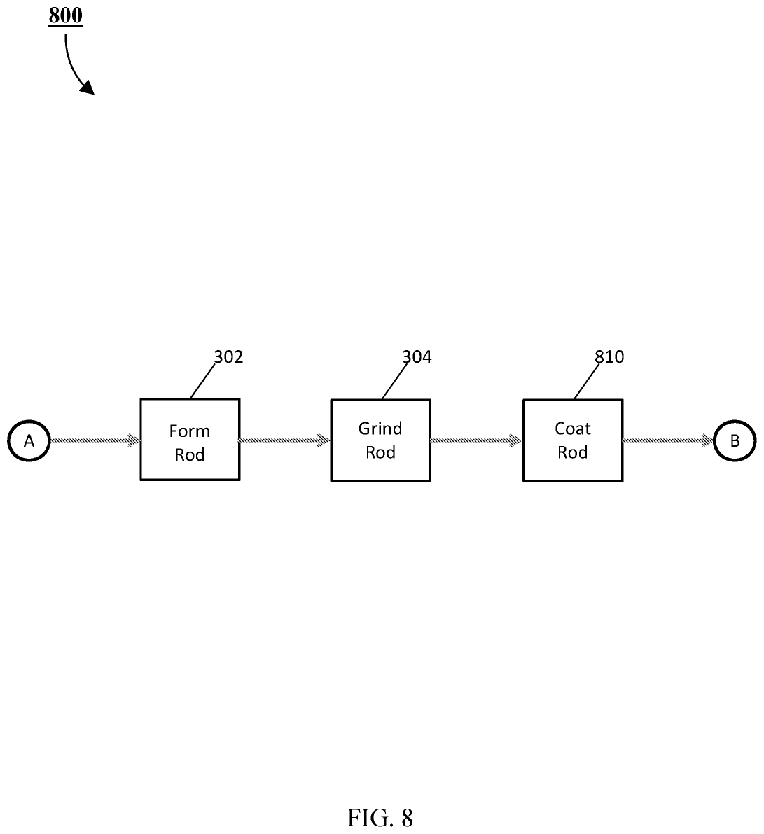

In another exemplary embodiment, a method 800 of forming an improved composite rebar 900 is shown in FIG. 8. The method 800 involves forming the composite rod (step 302), grinding the rod to remove material therefrom to create the ribs (step 304), and thereafter coating those portions of the rod where material was removed (step 810). Any pre-forming processing is denoted by “A” in FIG. 8, while any post-coating processing is denoted by “B” in FIG. 8.

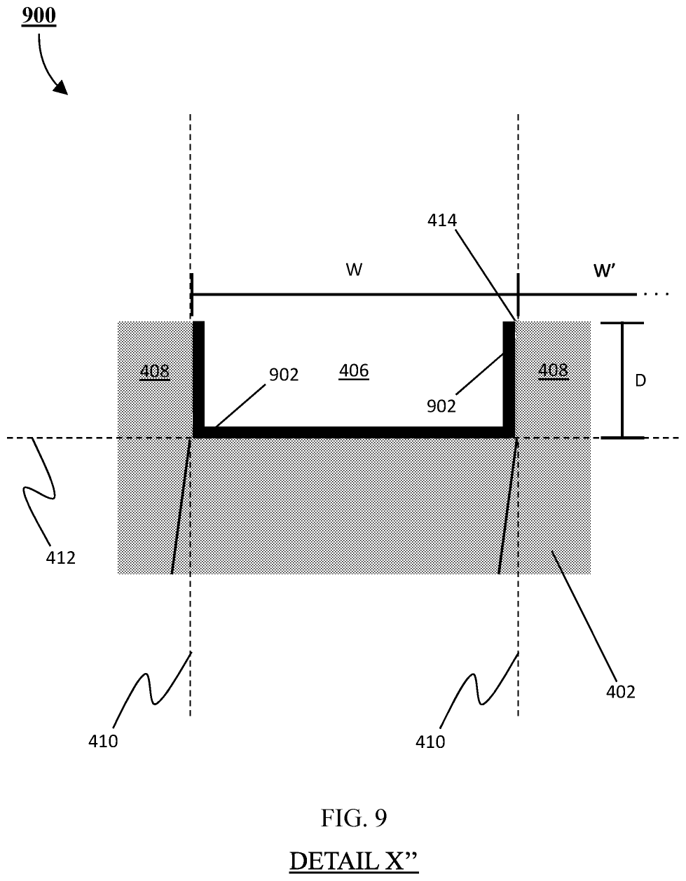

In step 810, the coating can be performed in any suitable manner. In some exemplary embodiments, a coating composition is applied on the protruding portions 414 extending beyond the lines 410 to entirely, or otherwise significantly, cover the protruding portions 414 and form coated surfaces 902, as shown in FIG. 9. Any suitable coating composition that is effective in covering the protruding portions 414 can be used, thereby providing a non-tacky surface treatment that improves handling of the composite rebar 900.

A measure of the surface roughness of the removed portions 406 (or any relevant portions thereof) after buffing is greatly reduced when compared to the surface roughness of the removed portions 406 prior to buffing.

In step 810, the composite rod is subject to an operation, such as spray coating, that covers a portion of the rod having fibers protruding therefrom. In the case of spray coating, the coating apparatus could follow the continuous (angled) channel formed by the grinding of the composite rod. Other coating techniques, such as curtain coating and vacuum coating, could also be used. In some exemplary embodiments, the coating apparatus is fixed, while the composite rod moves relative thereto. In some exemplary embodiments, the composite rod is fixed, while the coating apparatus moves relative thereto. In some exemplary embodiments, only the removed portions 406 (e.g., the helical channel 404) or some portions thereof are coated. In some exemplary embodiments, both the removed portions 406 (e.g., the helical channel 404) and the remaining portions 408 are coated.

A portion of the resulting composite rebar 900 having the coated surfaces 902 is shown in FIG. 9, which is a modified version of the detailed view of FIG. 5. Typically, the coating will be applied to all surfaces of the composite rod (or at least all surfaces from which material has been removed), as shown in FIG. 9. Because of the coating operation, the protruding portions 414 (created by the grinding operation) have been completely or significantly covered. In other words, a surface smoothness of the helical channel 404 is increased by virtue of the coating operation (i.e., the coated surface 902), which renders the composite rebar 900 more safe/comfortable to handle.

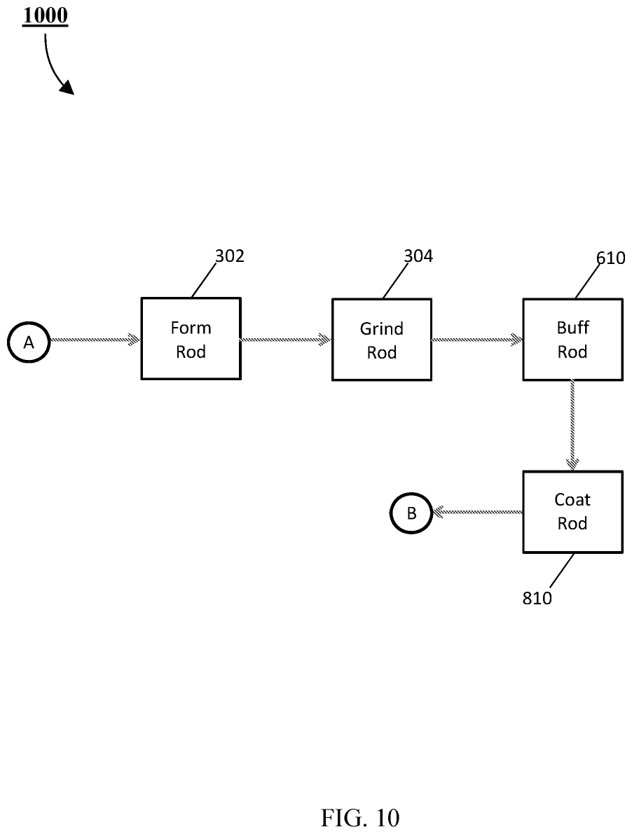

In yet another exemplary embodiment, a method 1000 of forming an improved composite rebar 1100 is shown in FIG. 10. The method 1000 involves forming the composite rod (step 302), grinding the rod to remove material therefrom to create the ribs (step 304), thereafter buffing those portions of the rod where material was removed (step 610), and then coating those portions of the rod where material was removed (step 810). Any pre-forming processing is denoted by “A” in FIG. 10, while any post-coating processing is denoted by “B” in FIG. 10.

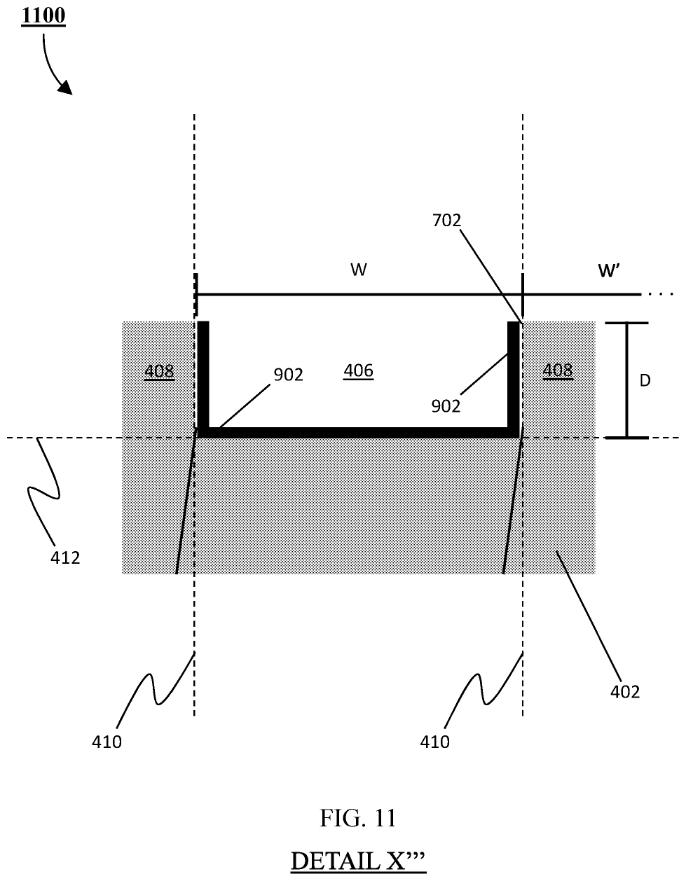

In step 610, the buffing can be performed in any suitable manner. In some exemplary embodiments, a finely abrasive material is used to polish the protruding portions 414 extending beyond the lines 410 to entirely, or otherwise significantly, remove the protruding portions 414 and form buffed surfaces 702, as shown in FIG. 11. Examples of buffing techniques include, but are not limited to, use of an abrasive wheel, a scouring pad, a sanding device, a fibrous brush, or deburring chips.

In step 610, the composite rod is subject to an operation, such as mechanical buffing, that smooths a portion of the rod having fibers protruding therefrom. In the case of mechanical buffing, the buffing apparatus will typically follow the continuous (angled) channel formed by the grinding of the composite rod. In some exemplary embodiments, the buffing apparatus is fixed, while the composite rod moves relative thereto. In some exemplary embodiments, the composite rod is fixed, while the buffing apparatus moves relative thereto.

In step 810, the coating can be performed in any suitable manner. In some exemplary embodiments, a coating composition is applied on the buffed surfaces 702 to form coated surfaces 902, as shown in FIG. 11. The coating is applied on at least the buffed surfaces 702 to entirely, or otherwise significantly, cover any remaining protruding portions 414 extending above the buffed surfaces 702. Furthermore, the coating can protect the buffed surfaces 702 from abrasion during shipping and/or storage of the composite rebar 1100 that might otherwise cause fibers to again protrude from the removed portions 406.

In step 810, the composite rod is subject to an operation, such as spray coating, that covers a portion of the rod having the buffed surfaces 702. In some exemplary embodiments, the coating apparatus is fixed, while the composite rod moves relative thereto. In the case of spray coating, the coating apparatus could follow the continuous (angled) channel formed by the grinding of the composite rod. Other coating techniques, such as curtain coating and vacuum coating, could also be used. In some exemplary embodiments, the coating apparatus is fixed, while the composite rod moves relative thereto. In some exemplary embodiments, the composite rod is fixed, while the coating apparatus moves relative thereto. In some exemplary embodiments, only the removed portions 406 (e.g., the helical channel 404) or some portions thereof are coated. In some exemplary embodiments, both the removed portions 406 (e.g., the helical channel 404) and the remaining portions 408 are coated.

A measure of the surface roughness of the removed portions 406 after buffing and coating is greatly reduced when compared to the surface roughness of the removed portions 406 prior to buffing and coating.

A portion of the resulting composite rebar 1100 having the buffed surfaces 702 with the coated surfaces 902 is shown in FIG. 11, which is a modified version of the detailed view of FIG. 5. Typically, the coating will be applied to all surfaces of the composite rod (or at least all surfaces from which material has been removed), as shown in FIG. 11. Because of the buffing operation, the protruding portions 414 (created by the grinding operation) have been removed or otherwise reduced. Because of the coating operation, any remaining protruding portions 414 (created by the grinding operation) have been completely or significantly covered. In other words, a surface smoothness of the helical channel 404 is increased by virtue of the buffing and coating operations, which renders the composite rebar 1100 more safe/comfortable to handle.

The methods disclosed or otherwise suggested herein can be implemented as a continuous/in-line process, although it is possible that the methods could be implemented otherwise. For example, the grinding process and the buffing process could form a primary process to be followed by the coating process and a curing process (that sets the coating) as a (separate) secondary process.

It will be appreciated that the scope of the general inventive concepts is not intended to be limited to the particular exemplary embodiments shown and described herein. From the disclosure given, those skilled in the art will not only understand the general inventive concepts and their attendant advantages, but will also find apparent various changes and modifications to the articles disclosed herein, including the associated methods and systems for making same. For example, while various illustrative embodiments are shown and described herein that include a helical channel formed in a composite rod, the general inventive concepts contemplate and encompass any type of anchor points formed in a composite rod by removal of material from the rod (e.g., discrete concentric grooves spaced apart from one another). As another example, while the buffing and coating operations are shown and described herein as applied to side walls of a helical channel form in a composite rod, the buffing and/or coating operations can be applied to any surface of the helical channel wherein fibers protrude to create an undesirable rough surface. It is sought, therefore, to cover all such changes and modifications as fall within the spirit and scope of the general inventive concepts, as described and claimed herein, and any equivalents thereof.

1-17. (canceled)

18. A method of forming a composite rebar, the method comprising:
forming a rod by combining a plurality of relatively parallel fibers with a resin, said resin being cured to solidify the rod;
grinding the rod to remove a portion of the fibers and the resin to form a helical groove therein;
buffing a surface of the helical groove; and
coating the surface of the helical groove after said buffing.

19. The method of claim 18, wherein the fibers are glass fibers.

20. The method of claim 18, wherein the resin is one of a vinyl ester resin and an epoxy resin.

21. The method of claim 18, wherein the helical groove is continuous along a length of the rod.

22. The method of claim 21, wherein the helical groove has a width in the range of 0.200 inches to 0.260 inches; and
wherein the helical groove has a depth in the range of 0.007 inches to 0.020 inches.

23. The method of claim 22, wherein the helical groove has a pitch in the range of 0.380 inches to 0.420 inches.

24. The method of claim 21, wherein the helical groove has a width in the range of 0.240 inches to 0.260 inches; and
wherein the helical groove has a depth in the range of 0.008 inches to 0.016 inches.

25. The method of claim 24, wherein the helical groove has a pitch in the range of 0.380 inches to 0.420 inches.

26. The method of claim 18, wherein the helical groove has a width;
wherein the helical groove has a depth; and
wherein the width is greater than the depth.

27. The method of claim 18, wherein the helical groove has a first width;
wherein a portion of the rod adjacent to the helical groove has a second width; and
wherein the first width is greater than the second width.

28. A composite rebar comprising a rod comprising a plurality of relatively parallel fibers joined by a cured resin, wherein a continuous helical groove is formed along a length of the rod, and wherein the helical groove has at least one of a buffed surface and a coated surface.

29. The composite rebar of claim 28, wherein the fibers are glass fibers.

30. The composite rebar of claim 28, wherein the resin is one of a vinyl ester resin and an epoxy resin.

31. The composite rebar of claim 28, wherein the helical groove has a width in the range of 0.200 inches to 0.260 inches; and
wherein the helical groove has a depth in the range of 0.007 inches to 0.020 inches.

32. The composite rebar of claim 31, wherein the helical groove has a pitch in the range of 0.380 inches to 0.450 inches.

33. The composite rebar of claim 28, wherein the helical groove has a width in the range of 0.240 inches to 0.260 inches; and
wherein the helical groove has a depth in the range of 0.008 inches to 0.016 inches.

34. The composite rebar of claim 33, wherein the helical groove has a pitch in the range of 0.380 inches to 0.450 inches.

35. The composite rebar of claim 28, wherein the helical groove has a width;
wherein the helical groove has a depth; and
wherein the width is greater than the depth.

36. The composite rebar of claim 28, wherein the helical groove has a first width;
wherein a portion of the rod adjacent to the helical groove has a second width; and
wherein the first width is greater than the second width.
